(19) United States
(12) Patent Application Publication
(10) Pub. No.: US 2024/0359546 A1
(43) Pub. Date: Oct. 31, 2024

(54) FLOW GUIDING DEVICE FOR BEING INSTALLED ON A PANEL COMPONENT

(71) Applicant: Webasto SE, Stockdorf (DE)

(72) Inventor: Magnus SVIBERG, Stockdorf (DE)

(21) Appl. No.: 18/688,476

(22) PCT Filed: Sep. 16, 2022
(86) PCT No.: PCT/EP2022/075803

§ 371 Date: Mar. 1, 2024

(30) Foreign Application Priority Data
Sep. 16, 2021 (DE) 10 2021 123 989.3

(51) Int. Cl. B60J 7/22; B60R 11/04; B60S 1/56

(52) U.S. Cl. CPC B60J 7/22; B60R 11/04; B60S 1/56

(57) ABSTRACT

A flow guiding device for being installed on a panel component of a motor vehicle, the flow guiding device may have at least one flow guiding element configured to deflect headwind in a predetermined manner, and a driving mechanism configured to move the at least one flow guiding element between a retracted position and at least one deployed position. The at least one flow guiding element may have at least one environment sensor configured to send and/or receive electromagnetic signals for detecting a vehicle environment and to be moved between the retracted position and the at least one deployed position together with the at least one flow guiding element.

### CROSS-REFERENCE TO RELATED APPLICATIONS

This application is a U.S. national phase application filed under 35 U.S.C. § 371 of International Application No. PCT/EP2022/075803, filed on Sep. 16, 2022, published under WO 2023/041726 A1 on Mar. 23, 2023, designating the United States, which claims priority from German Patent Application Number 10 2021 123 989.3, filed on Sep. 16, 2021, which are hereby incorporated herein by reference in their entirety.

### FIELD

The invention relates to a flow guiding device for being installed on a panel component according to the preamble of claim 1.

### BACKGROUND

In vehicle construction, generic flow guiding devices are widely used in the form of spoilers or wind deflectors in order to deflect headwind from the vehicle body in a predetermined direction. For instance, flow guiding devices are used in convertible vehicles or sliding roofs and are disposed at least in front of the roof opening when viewed in the direction of travel. A flow guiding device disposed in this manner allows headwind to be deflected in such a manner that it can no longer enter a vehicle interior when the sliding roof is open. As a result, passengers are no longer disturbed by headwind while the motor vehicle is moving. The flow guiding devices can be disposed rigidly on an outer side of a roof skin or a panel component. Alternatively, the known flow guiding devices can also be retractable and deployable, which has the advantage that the flow guiding devices are deployed only when the roof opening is open.

Alternatively or additionally, flow guiding devices are also known as front and/or rear spoilers on motor vehicles. Such a configuration is chosen more for aerodynamic reasons, for example to increase the contact pressure of the motor vehicle on the road. It is known that flow guiding devices of this kind are deployed, for example, at a predetermined threshold speed in order to continue to provide the driver with controlled driving behavior.

Developments in the automotive sector are also increasingly focusing on roof modules which can be prefabricated as separate functional modules and delivered to the assembly line during vehicle assembly. Such a roof module at least partially forms a roof skin of the vehicle roof at its outer surface, the roof skin preventing moisture or airflows from entering the vehicle interior. The roof skin is formed by one or more panel components, which can be made of a stable material, such as painted metal or painted or died-through plastic. The roof module can be part of a fixed vehicle roof or part of an openable roof assembly (for example with a panoramic roof, a sunroof or a sliding roof).

Furthermore, special attention is also being focused on the development of autonomous or semi-autonomous motor vehicles. In order to enable the vehicle control system to control the motor vehicle autonomously or semi-autonomously, a plurality of environment sensors (e.g., lidar sensors, radar sensors, (multi-) cameras, etc. including other (electrical) components) are used, which are integrated into the roof module, detect the environment around the motor vehicle, for example, and determine a current traffic situation, for example, from the detected environmental data. Roof modules which are equipped with a plurality of environment sensors are also known as roof sensor modules (RSM). The known environment sensors send or receive suitable electromagnetic signals, such as laser beams or radar beams, allowing a data model of the vehicle environment to be generated by suitable signal evaluation and used for vehicle control.

The environment sensors for monitoring and recording the vehicle environment are usually attached to the vehicle roof as a separate unit, as the vehicle roof is usually the highest point of a vehicle, from which the vehicle environment is clearly visible. The environment sensors are usually mounted as an attachment on top of the panel component of the roof module that forms the roof skin. It is also generally known for retractable and deployable environment sensors to be disposed in an opening in the roof skin as a separate unit.

However, known placement solutions environment sensors on panel components, in particular in the roof area of the motor vehicle, have a number of disadvantages that need to be overcome. In the state of the art, for example, it is necessary to provide a separate opening in the roof skin for each environment sensor or sensor module if it is to be retractable and deployable. This in turn requires installation space, which is only available to a limited extent in the automotive sector. In addition, known placement solutions environment sensors often require a compromise between design specifications, installation space and/or the required range of functions, which, depending on the motor vehicle, may not correspond to a solution desired by the customer. There is therefore still a need to improve the placement options for environment sensors.

### SUMMARY

Due to the disadvantages mentioned above, the object of the invention is to improve the placement of environment sensors.

This object is attained by a roof module according to the teaching of claim 1.

Advantageous embodiments of the invention are the subject of the dependent claims.

In its intended use (i.e., when disposed on a motor vehicle so as to act as a spoiler or wind deflector), the flow guiding device according to the invention is configured to be disposed on a panel component of a motor vehicle. The flow guiding device comprises at least one flow guiding element configured to deflect headwind in a predetermined manner (while the motor vehicle is in motion). Furthermore, the flow guiding device comprises a driving mechanism configured to move the at least one flow guiding element between a retracted position and at least one deployed position. The flow guiding device is characterized in that the at least one flow guiding element comprises at least one environment sensor which is configured to send and/or receive electromagnetic signals for detecting a vehicle environment and which can thus be moved between the retracted position and the at least one deployed position together with the at least one flow guiding element.

Particularly preferably, the invention relates to a roof module for forming a vehicle roof on a motor vehicle, the roof module comprising a panel component which at least partially forms a roof skin of the vehicle roof, the roof skin serving as an outer sealing surface of the roof module, and a flow guiding device comprising at least one flow guiding element disposed on the panel component and configured to deflect headwind from the panel component in a predetermined manner. The flow guiding device comprises a driving mechanism configured to move the at least one flow guiding element between a retracted position, in which the flow guiding element is preferably flush with the roof skin, and at least one deployed position, in which the flow guiding element protrudes from the roof skin. The preferred roof module is characterized in that the at least one flow guiding element comprises at least one environment sensor configured to send and/or receive electromagnetic signals for detecting a vehicle environment and to be moved between the retracted position and the at least one deployed position together with the at least one flow guiding element. The at least one flow guiding element is preferably disposed on the panel component of the roof module in such a manner that it functions as a headwind spoiler and/or a wind deflector.

The inventors have recognized in the present case that it is advantageous for the at least one environment sensor to be disposed in or on the at least one flow guiding element in terms of installation space in particular since the driving mechanism of the flow guiding device is thus used synergistically for moving the at least one environment sensor between the retracted position and the at least one deployed position together with the flow guiding element. Unlike in the prior art, no additional mechanism is required for retracting and deploying the environment sensor. Instead, the environment sensor is disposed on the flow guiding element in such a manner that it can be retracted and deployed together with it. The environment sensor is disposed in such a manner that it forms part of the flow guiding element. So if the flow guiding element is moved from the retracted position to the deployed position, the environment sensor is also moved to the deployed position at the same time, as it forms part of the flow guiding element. Since the flow guiding element preferably protrudes above the roof skin in the at least one deployed position, the environment sensor also preferably protrudes above the roof skin in this position in such a manner that it can detect the vehicle environment with as unobstructedly as possible, i.e., its view is not obstructed by parts of the roof skin. In other words, the integration and/or placement of one or more environment sensors as provided by the invention, which are preferably used for autonomous driving, in a flow guiding element of a motor vehicle designed as a spoiler and/or wind stopper means that only one common drive mechanism has to be used, which means that installation space can be saved compared to the state of the art. The flow guiding device according to the invention or the aforementioned particularly preferred roof module have several advantages over the prior art. For example, the placement of the environment sensor in or on the flow guiding element as provided by the invention not only leads to an optimization of the installation space but also to a harmonization of the overall design of the roof module and/or the motor vehicle since the integration of the environment sensor results in fewer interfering contours. At the same time, the flow guiding device according to the invention in its intended use (i.e., its placement on a panel component (for example a roof module) of a motor vehicle) leads to an improvement in motor vehicle aerodynamics and thus to lower energy consumption. The shape of the at least one flow guiding element itself is already aerodynamically optimized due to its function. According to the invention, there is therefore no need for a separate environment sensor to be disposed on the panel component, which could possibly have a negative influence on the aerodynamics, since such an environment sensor is already disposed in or on the at least one flow guiding element. Overall, a vehicle layout and a vehicle installation space can therefore be optimized, in particular with regard to the placement of environment sensors. The flow guiding device according to the invention also leads to a cost optimization for the required components due to the synergetic use of installation space by the environment sensor and the flow guiding element and thus also reduces the overall costs.

The at least one (in particular aerodynamically shaped) flow guiding element can basically have any geometric shape, which is preferably designed to guide a flow (in this case headwind) along a predetermined contour of the flow guiding element in such a manner that the flow is guided along the contour and leaves the contour in a tangential direction in a predetermined release area (viewed with respect to the contour in the release area). A deflection of the headwind by the flow guiding element is predetermined or defined by the geometric properties of the flow guiding element in the at least one deployed state. A flow guiding element is understood here to mean any type of body that is designed to guide a flow in a certain direction. The flow guiding element can be understood in the manner of a spoiler, for example. A motor vehicle in question or a panel component of a motor vehicle can basically have one or more flow guiding elements. It is understood that the flow guiding element can also be deployed into several positions, which can be located between the retracted position and a maximum possible deployed position.

“At least one” means that one or more of the components in question may be present. For example, “at least one environment sensor” can mean that the flow guiding device or the roof module can comprise one or more environment sensors, which can be disposed in or on one or more flow guiding elements. A field of view of the environment sensor preferably extends symmetrically around the optical axis of the environment sensor in the form of a cone with a sensor-specific cone opening angle.

The particularly preferred roof module can form a structural unit in which devices for autonomous or semi-autonomous driving supported by driver assistance systems are integrated and which can be mounted as a unit on top of a vehicle body by a vehicle manufacturer. Furthermore, the preferred roof module can be designed as a purely fixed roof or as a roof with a roof opening system. Moreover, the roof module can be designed for use in a passenger car or in a utility vehicle. The roof module can preferably be provided as a structural unit in the form of a roof sensor module (RSM) in which the environment sensors are provided in order to be inserted into a roof frame or into a roof frame structure of a vehicle body as a deliverable structural unit.

In principle, the environment sensor of the roof module according to the invention can be designed in a variety of ways and in particular comprise a lidar sensor, a radar sensor, an optical sensor, such as a camera, and/or the like. Lidar sensors, for example, operate in a wavelength range of 905 nm or about 1550 nm. The material of the roof skin in the see-through area should be transparent for the wavelength range used by the environment sensor and should therefore be selected as a function of the wavelength(s) used by the environment sensor.

In a preferred embodiment, the at least one environment sensor is integrated in or disposed on the at least one flow guiding element. The environment sensor can therefore either be fully integrated in the flow guiding element, meaning the flow guiding element forms a kind of housing or installation space for the environment sensor, in which the environment sensor is disposed. However, the environment sensor can basically also be disposed on the flow guiding element in a different manner and not necessarily integrated in it. The flow guiding element can, for example, be made of plastic or metal, preferably sheet metal, and thus provide a housing for the environment sensor and at least partially also for the driving mechanism or parts thereof. The flow guiding element can, for example, be formed by injection molding or as a deep-drawn component, in particular with a tray-shaped design, and thus form a mounting space in which the at least one environment sensor can be disposed. The at least one environment sensor is preferably disposed rigidly, i.e., immovably, relative to the flow guiding element, with the result that a movement of the flow guiding element also leads directly to a movement of the environment sensor. However, it is basically also possible for the environment sensor to be movable along an axis and/or about an axis relative to the flow guiding element and, for example, to be telescopically retractable and deployable from the flow guiding element.

In a preferred embodiment, the at least one flow guiding element comprises at least one see-through area through which the environment sensor can send and/or receive electromagnetic signals to detect the vehicle environment. The see-through area is preferably at least partially formed on the flow guiding element and can, for example, be formed on the flow guiding element in the manner of a window. The see-through area is preferably completely transparent with respect to a wavelength range used by the at least one environment sensor but can be opaque or impermeable and/or reflective for other wavelength ranges. The flow guiding element can have multiple see-through areas if, for example, multiple environment sensors are integrated in the flow guiding element. The flow guiding element can also have only a single see-through area, which can be used jointly by multiple environment sensors. The see-through area is preferably disposed on the flow guiding element in such a manner that it protrudes preferably completely, but at least partially, above a panel component on which the flow guiding element is disposed when in the deployed position in order to ensure that the environment sensor has as unobstructed a view as possible into the vehicle environment. It is understood that the environment sensor is oriented in such a manner relative to the flow guiding element and the see-through area that it can detect the vehicle environment with as little interference as possible in the at least one deployed state of the flow guiding element.

In a preferred embodiment, the at least one flow guiding element comprises at least one cleaning mechanism having at least one cleaning nozzle. Particularly preferably, the at least one cleaning nozzle is disposed on or integrated in the flow guiding element in such a manner that it can be moved between the retracted position and the at least one deployed position together with the flow guiding element. The flow guiding element can therefore still provide an installation space in which a cleaning mechanism for cleaning the see-through area of the environment sensor can be disposed. The at least one cleaning nozzle is configured to clean the see-through area of the environment sensor, which is preferably provided on the flow guiding element. A gaseous or liquid cleaning fluid can be used for this purpose. Furthermore, the flow guiding element can comprise one or more cleaning lines and/or valves and/or a tank. All these components can preferably be disposed in an installation space provided by the flow guiding element, as the letter is preferably a tray-shaped component. At least in the deployed state of the flow guiding element, the at least one cleaning nozzle can be movable in translation along an axis or in rotation about an axis relative to the flow guiding element. The cleaning mechanism can also have a wiper by means of which the see-through area can be cleaned in the manner of a windshield wiper.

In a preferred embodiment, the at least one flow guiding element comprises at least one light source disposed on or integrated in the flow guiding element in such a manner that it can be moved between the retracted position and the at least one deployed position together with the flow guiding element. Light sources of this kind are part of a system comprising lights for indicating autonomous driving mode and are supposed, for example, to indicate the current status of the autonomous vehicle to other road users, e.g., whether it will stop at a crosswalk. Such a placement of the light sources is advantageous, as it can save installation space.

In a preferred embodiment, the driving mechanism comprises a hydraulic and/or pneumatic and/or electric and/or mechanical drive. So the drive can comprise, for example, an electric motor and/or a hydraulic and/or a pneumatic drive and/or a mechanical drive. The adjustment drive can also comprise a Bowden cable and/or a flexible shaft and/or one or more lever elements and/or a single-stage or multi-stage gear mechanism and/or a return spring and/or the like. In addition, any combination of drive components is possible in principle, which means the list described above is by no means to be understood as restrictive. For example, a sliding guide with a slideway can also be used. A lever assembly can also be used. The flow guiding element can also be movable using multi-joint kinematics. The only important aspect is that the drive is directly or indirectly configured to move the at least one flow guiding element between the retracted position and the at least one deployed position. For this purpose, the flow guiding element can be rotated around one or more axes and/or moved in translation along one or more axes, for example. So a complex sequence of movements consisting of multiple rotational and translational partial movements for moving the flow guiding element in a predetermined manner is possible.

In a preferred embodiment, the at least one environment sensor can be activated by the movement of the at least one flow guiding element from the retracted position to the at least one deployed position so that it detects the vehicle environment, and deactivated by the movement of the at least one flow guiding element from a deployed position to the retracted position so that the at least one environment sensor is switched off or is in an idle mode. Such an activation or deactivation can be achieved, for example, by one or more motion-sensitive and/or light-sensitive sensors, which can be disposed on the flow guiding element. In this manner, the environment sensor can only be activated, for example, when the at least one flow guiding element is moved into the at least one deployed position, and is therefore not permanently activated. This type of environment sensor activation or deactivation is particularly advantageous, as fewer additional components are required. This type of sensor control is therefore more cost-effective overall.

The flow guiding element can basically comprise any type of environment sensor. The use of lidar sensors and/or radar sensors and/or camera sensors and/or multi-camera sensors and/or an ultrasonic sensor and/or a rain sensor is particularly advantageous.

Also preferred is a motor vehicle comprising a panel component and at least one flow guiding device according to the invention, which is disposed on the panel component in such a manner that the at least one flow guiding element can be moved between the retracted position and the at least one deployed position. The flow guiding device can basically be dispose don any panel component of the motor vehicle. The panel component preferably forms part of the vehicle body, i.e., it can basically be part of a roof skin, a hood, a rear cover, a wheel arch cover or the like.

Preferably, the at least one flow guiding element is flush with the panel component in the retracted position. In the at least one deployed position, the flow guiding element protrudes at least partially from the panel component in order to act as a headwind spoiler. In the deployed position, the flow guiding element preferably protrudes over the panel component at least far enough for a preferred see-through area of the environment sensor to completely protrude over the roof skin in order to ensure an unobstructed view into the vehicle environment for the environment sensor.

Particularly preferably, the at least one flow guiding element forms a front spoiler, a rear spoiler, a side spoiler, a trunk lid spoiler, a wind deflector of a sunroof, a wind deflector of a convertible vehicle or a wind deflector of a sliding roof when in the deployed state. For this purpose, the at least one flow guiding element is preferably disposed on a corresponding panel component of the motor vehicle, which preferably forms part of the vehicle body. Other placements of the at least one flow guiding element not mentioned here are also conceivable and are not intended to be exhaustive.

Furthermore, a roof module for forming a vehicle roof on a motor vehicle is preferred. The roof module preferably has a panel component at least partially forming a roof skin of the vehicle roof. The roof skin serves as an outer sealing surface of the roof module. Furthermore, the preferred roof module comprises a roof opening system which comprises a lid element. The lid element can be shifted to selectively open and/or close a roof opening. Furthermore, the preferred roof module comprises at least one flow guiding device according to the invention. The flow guiding device, in particular the flow guiding element, is designed as a wind deflector and/or as a headwind spoiler and disposed on the panel component in such a manner that it can be moved between the retracted position and the at least one deployed position. The flow guiding element is configured in particular to deflect headwind from the roof opening (especially when in the open state) so that vehicle occupants are not negatively affected by it. The flow guiding element therefore acts as a wind deflector. The flow guiding element can also be used as a headwind spoiler which can increase the contact pressure of the vehicle on a road surface at least at a predetermined speed. The headwind spoiler preferably improves the aerodynamics of the vehicle.

The roof opening system preferably comprises a sliding-roof kinematic system configured to open and/or close the roof opening by shifting the lid element. Basically any drive can be used for the sliding-roof kinematic system. In particular, electric drives and/or electromechanical drives are suitable. The sliding-roof kinematic system can also comprise a gear mechanism, a Bowden cable, a flexible-shaft drive or the like. The lid element is preferably guided in guide rails, which are disposed, for example, on a roof frame of the roof module. In principle, such guide rails can be aligned parallel to a longitudinal vehicle direction and/or parallel to a vehicle width direction.

In a preferred embodiment, the sliding-roof kinematic system is configured to communicate with the driving mechanism. The sliding-roof kinematic system can, for example, be in a control loop connection with the driving mechanism. The sliding-roof kinematic system and the driving mechanism can preferably be controlled by a common control system. It is also possible for the sliding-roof kinematic system to transmit one or more control commands to the driving mechanism, for example when the lid element is opened, in order to cause the driving mechanism to also deploy the flow guiding element. A similar interaction is also conceivable for retraction or closing. A mechanical or other direct or indirect coupling of the sliding-roof kinematic system with the driving mechanism (or the drive) is also conceivable. For example, the sliding-roof kinematic system can interact with the drive of the driving mechanism via a Bowden cable or a flexible shaft. Alternatively, the sliding-roof kinematic system itself can also form the driving mechanism of the flow guiding device. So the sliding-roof kinematic system can comprise the driving mechanism, meaning only the sliding-roof kinematic system is necessary for moving both the lid element and the flow guiding element.

In a preferred embodiment, a motor vehicle comprises a roof frame structure and one of the aforementioned roof modules. The roof module can be mounted on top of the roof frame structure as a structural unit. So the roof module can be placed on top the roof frame structure as a single part.

It is understood that the embodiments and embodiment examples mentioned above and to be explained below can be realized not only individually but also in any combination with one another without departing from the scope of the present invention. Moreover, all embodiments and embodiment examples of the flow guiding device relate in their entirety and in equivalent form to a motor vehicle comprising such a flow guiding device. Furthermore, all embodiments and embodiment examples of the flow guiding device relate in their entirety and in equivalent form to a roof module comprising such a flow guiding device.

### BRIEF DESCRIPTIONS OF THE DRAWINGS

An embodiment of the invention is schematically illustrated in the drawing and is explained below by way of example.

FIG. 1 is a perspective view of a vehicle roof with a roof module according to the invention;

FIG. 2 shows a first embodiment of a flow guiding device according to the invention on a panel component of a roof module with a sliding roof in two positions;

FIG. 3 shows the first embodiment example of a flow guiding device according to the invention on a panel component of a roof module with a sliding roof in two further positions;

FIG. 4 shows a second embodiment example of a flow guiding device according to the invention as a front-side vestibule on a panel component in a con-figuration behind a front-side vestibule in two positions;

FIG. 5 is a rear view of a third embodiment of a flow guiding device according to the invention as a rear spoiler on a panel component in two positions;

FIG. 6 is a side view of a fourth embodiment example of a flow guiding device according to the invention in two positions;

FIG. 7 is a side view of a fifth embodiment example of a flow guiding device according to the invention in two positions;

FIG. 8 is a side view of a sixth embodiment of a flow guiding device according to the invention in two positions;

FIG. 9 is a first detailed view of an embodiment example of a flow guiding device according to the invention;

FIG. 10 is a second detailed view of an embodiment example of a flow guiding device according to the invention;

FIG. 11 shows a schematic embodiment example of a possible placement of a flow guiding device according to the invention;

FIG. 12 shows a schematic embodiment example of a possible placement of a flow guiding device according to the invention;

FIG. 13 shows a schematic embodiment example of a possible placement of a flow guiding device according to the invention;

FIG. 14 shows a schematic embodiment example of a possible placement of a flow guiding device according to the invention; and

FIG. 15 shows a schematic embodiment example of a possible placement of a flow guiding device according to the invention.

### DETAILED DESCRIPTION

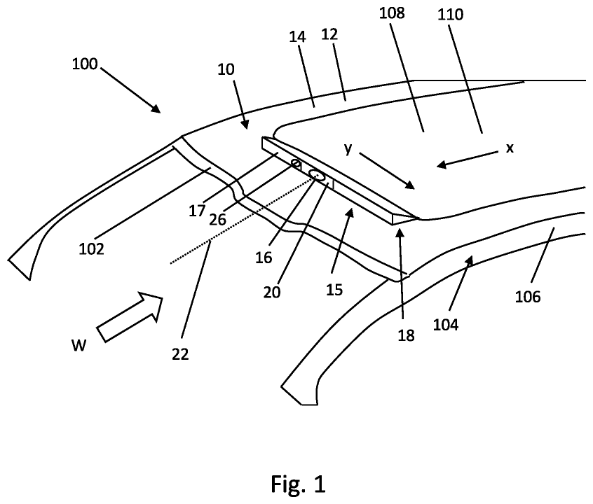

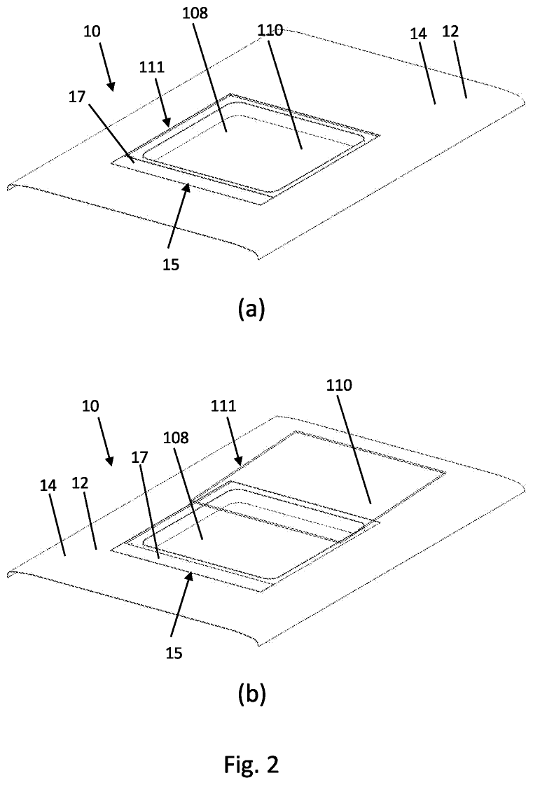

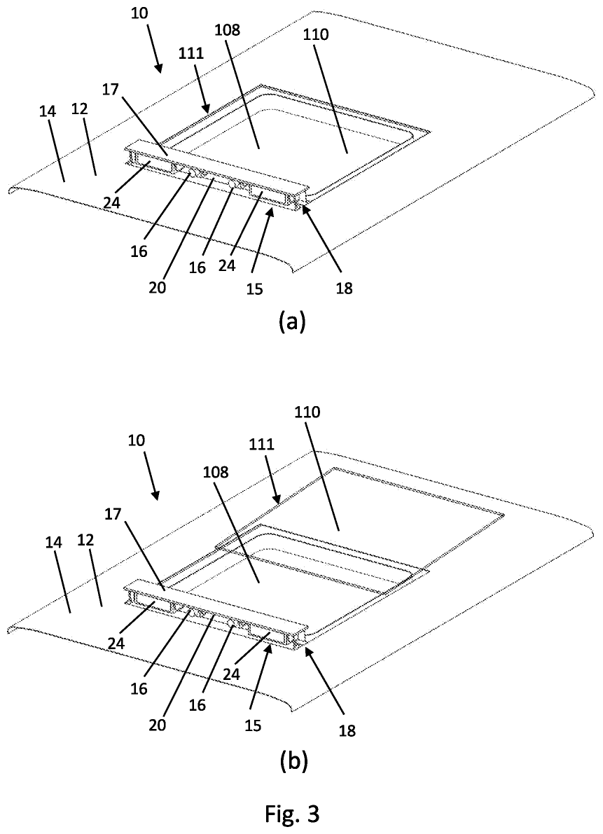

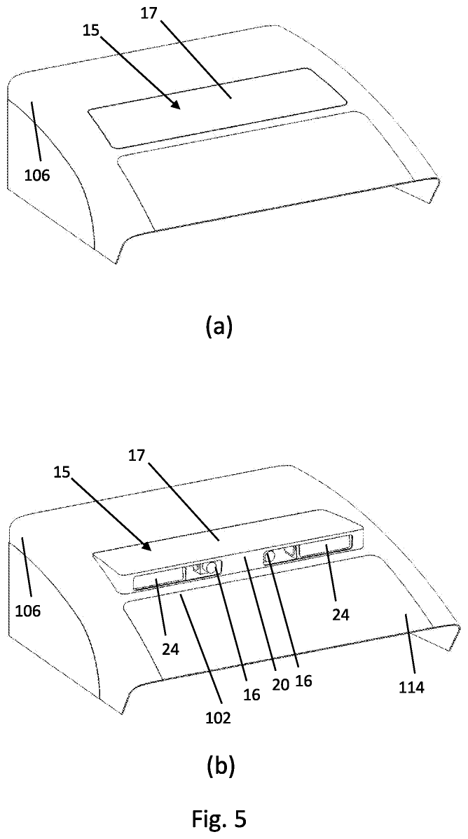

FIG. 1 shows a vehicle roof 100 of a vehicle (not shown in its entirety) comprising a roof module 10. The roof module 10 is preferably inserted into a roof frame structure 104 of the vehicle or placed on at least two transverse rails 102 and at least two longitudinal rails 106 of the vehicle body, which form the roof frame structure 104, as a structural unit. In the case shown, the roof module 10 comprises a roof opening 108. Furthermore, the roof module 10 comprises a roof opening system which has a lid element 110 which can be used to selectively open or close the roof opening 108 (see FIGS. 2 and 3), for example along guide rails (not shown). For opening and/or closing the roof opening 108 or moving the lid element 110, the roof opening system comprises an unspecified sliding-roof kinematic system 111. The front transverse rail forms a roof-side header, which connects to a windshield 112 of the vehicle. Furthermore, the motor vehicle can also comprise a rear transverse rail 102, which connects to a rear window 114 of the vehicle at the rear (see FIG. 5).

The roof module 10 comprises a panel component 12 for forming a roof skin 14 of the vehicle roof 100. In principle, however, the panel component can also be other parts of a vehicle body of the motor vehicle. A flow guiding device 15 is disposed symmetrically to the longitudinal vehicle axis x in a frontal area of the vehicle roof 100 or the roof module 10 (viewed in a longitudinal vehicle direction x, which corresponds to a direction of travel of the motor vehicle). The flow guiding device 15 comprises an environment sensor 16, which is integrated in a flow guiding element 17 of the flow guiding device 15 in the case at hand. In the case of FIGS. 1 to 4, the flow guiding element 17 serves as a wind deflector to prevent headwind W from entering the roof opening 108 when the latter is in an open state (see FIGS. 2(b) and 3(b)). In the case of FIGS. 1 to 4, the movable flow guiding element 17 is disposed directly behind the front transverse rail 102 on the panel component 12. In the case at hand, the at least one flow guiding element 17 can be moved between a retracted position and at least one deployed position by a driving mechanism 18. The driving mechanism 18 can comprise at least one hydraulic and/or pneumatic and/or electric and/or mechanical drive (not shown).

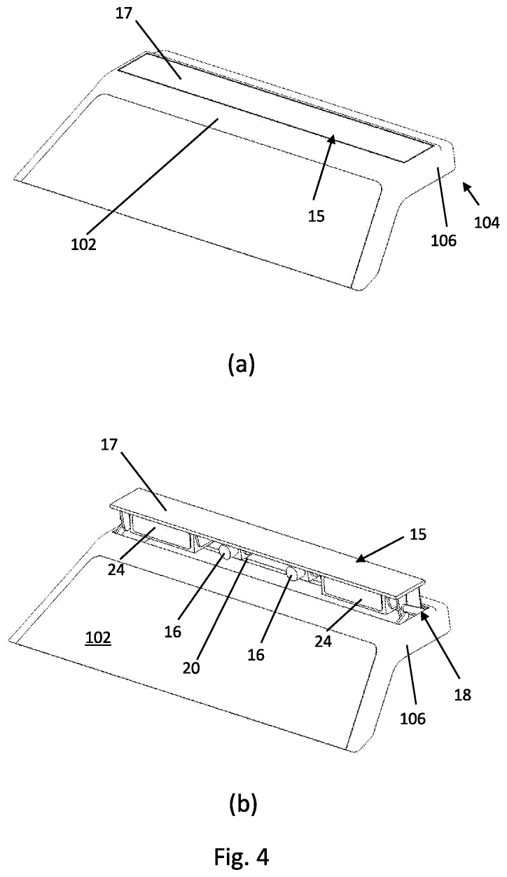

In the case at hand, the environment sensor 16 is integrated in the flow guiding element 17, the flow guiding element 17 forming a kind of housing for the environment sensor 16, in which other components can also be incorporated. The flow guiding element thus forms a dry area in which the at least one environment sensor is protected from moisture. The environment sensor 16 can thus be moved between the retracted position and at least one deployed position together with the flow guiding element 17. In the case of FIGS. 3 and 4, the flow guiding element 17 comprises two environment sensors 16 which look through a common see-through area 20. In the case of FIGS. 5, 9 and 10, the flow guiding element 17 has two separate see-through areas 20. The environment sensor 16 is a lidar sensor in the present case. However, other sensor types, e.g., (multidirectional) cameras, which are used in (semi-) autonomous driving, can also be used.

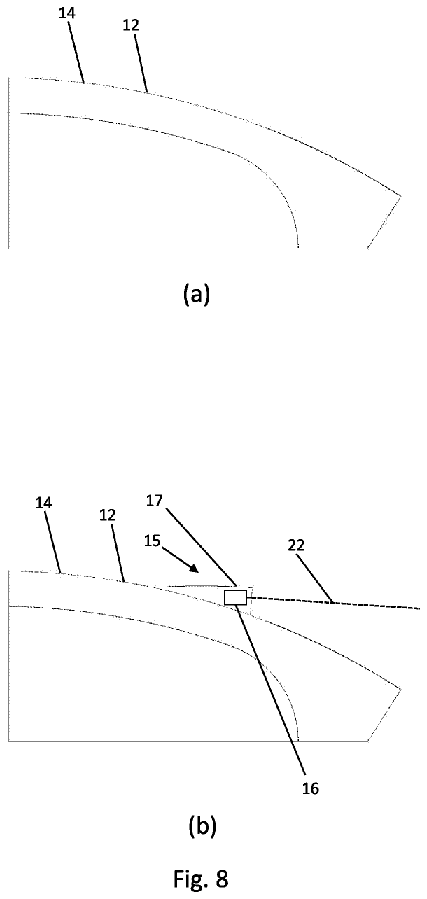

The flow guiding element 17 comprises the see-through area 20 in the form of a pane, which can be made of a preferably shatterproof plastic, glass or another (partially) transparent material, for example. The environment sensor 16 is oriented along an optical axis 22, which in the case of FIG. 1 is aligned parallel to the longitudinal vehicle direction x. In the case of FIG. 8(b), the optical axis 22 is inclined slightly (i.e., by approx. 5° to 15°) in the direction of the ground relative to the longitudinal vehicle direction x. A cone-shaped field of view of the environment sensor 16 in which the environment sensor 16 can send and/or receive electromagnetic signals in order to detect a vehicle environment extends around the optical axis.

In addition to the two environment sensors 16, other components that are advantageous for autonomous driving are also disposed in the flow guiding element 17, which can preferably be hollow-tray-shaped component. For example, two light sources 24 are also provided, which are configured to optically communicate with the environment when the vehicle is driving autonomously and indicate, for example, that the vehicle is driving autonomously, will stop at a traffic light or the like. In principle, additional components or other components, such as a cleaning mechanism 26 having at least one cleaning nozzle, can also be disposed in the flow guiding element 17 (see schematically in FIG. 1).

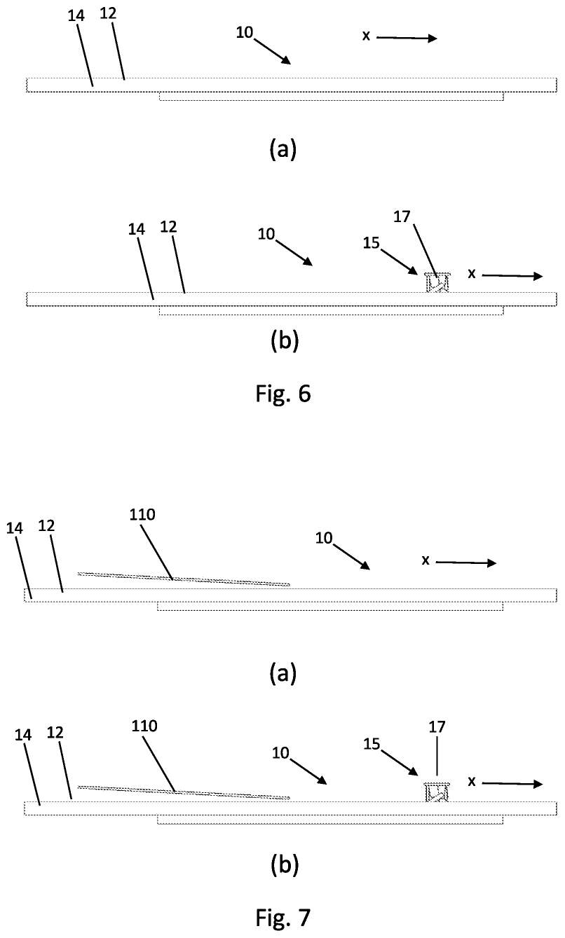

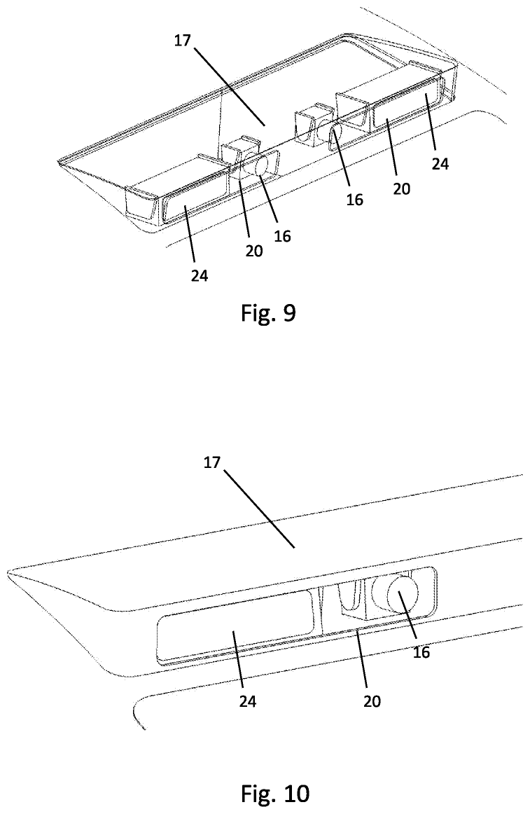

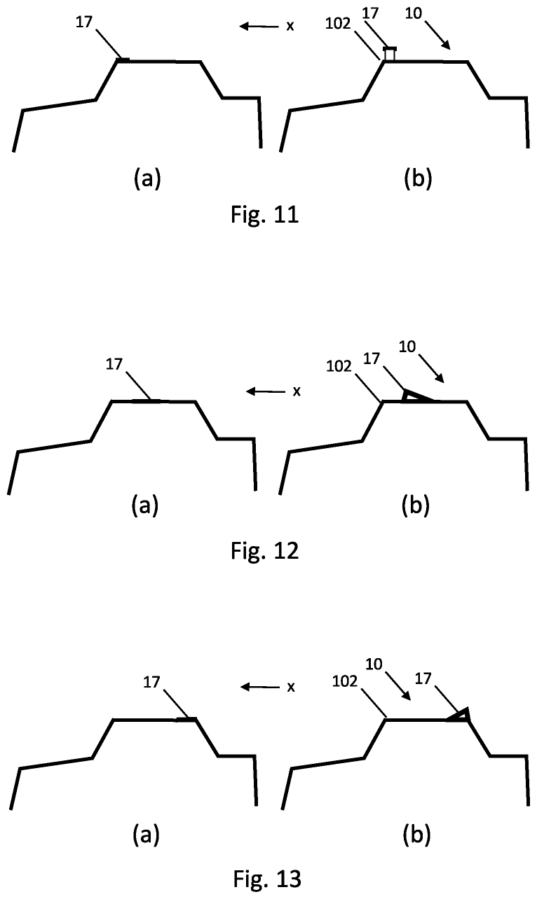

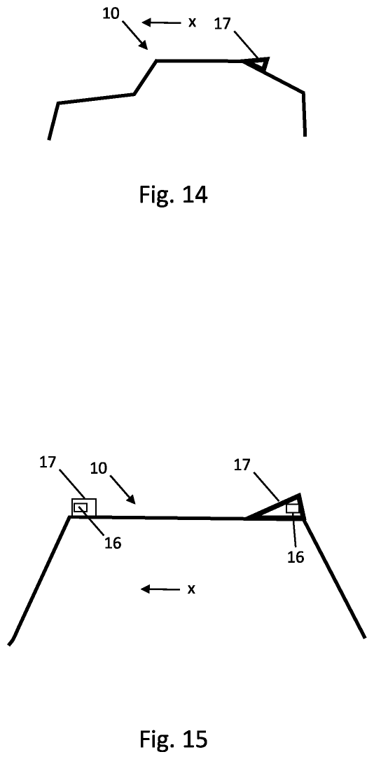

To summarize, FIGS. 1 to 4 show a flow guiding device 15 comprising a flow guiding element 17 which is configured to move between a retracted position (see FIGS. 2(a), 2(b) and 4(a)) and at least one deployed position (see FIGS. 1, 3(a), 3(b) and 4(b)). In this configuration, the flow guiding element forms a frontal wind deflector that prevents headwind W from entering the roof opening 108. In FIGS. 5 and 8, the flow guiding element 17 is disposed at the rear in the area of the rear transverse rail 102 and forms a rear spoiler in this configuration. FIGS. 6 and 7 show a side view of a roof module 10 orthogonal to the longitudinal vehicle direction x, the roof module according to FIG. 7, in contrast to FIG. 6, comprising the lid element 110 in the form of a sliding roof or sunroof. In FIGS. 6(a) and 7(a), the flow guiding element 17 is shown in the retracted position, in which the flow guiding element 17 or a panel of the flow guiding element 17 is flush with the roof skin 14. In this position, the environment sensor 16 is disposed below the roof skin 14. In FIGS. 6(b) and 7(b), the flow guiding element 17 is shown in the deployed position, in which the flow guiding element 17 and with it the environment sensor 16 protrude above the roof skin 14. FIGS. 9 and 10 each show detailed views of the flow guiding element 17 disposed at the rear of the vehicle, meaning the flow guiding element 17 forms a rear spoiler of the motor vehicle. FIGS. 11 to 15 schematically show non-exhaustive options of positioning a flow guiding element according to the invention on a vehicle. FIG. 11 shows the flow guiding element 17 disposed in the front and in the retracted position (FIG. 11(a)) and the deployed position (FIG. 11(b)), with the longitudinal vehicle direction x or the direction of travel x of the motor vehicle being indicated in each case for better orientation. The flow guiding element forms a wind deflector in this case. FIG. 12 shows he flow guiding element 17 disposed in the front and in the retracted position (FIG. 12(a)) and the deployed position (FIG. 12(b)), flow guiding element 17 being set back from the front transverse rail 102 when viewed in the direction of travel, with the longitudinal vehicle direction x or the direction of travel x of the motor vehicle being indicated in each case for better orientation. The flow guiding element forms a wind deflector in this case. FIG. 13 shows the flow guiding element 17 disposed in the rear and in the retracted position (FIG. 13(a)) and the deployed position (FIG. 13(b)), with the longitudinal vehicle direction x or the direction of travel x of the motor vehicle being indicated in each case for better orientation. The flow guiding element forms a rear spoiler in this case. FIG. 14 shows the flow guiding element 17 disposed on the trunk lid and in the deployed position, with the longitudinal vehicle direction x or the direction of travel x of the motor vehicle being indicated in each case for better orientation. In this case, the flow guiding element forms a trunk lid spoiler, which is disposed above the rear window 114. FIG. 15 shows a roof module 10 comprising both a flow guiding element 17 at the front and a flow guiding element 17 at the rear. The flow guiding element 17 is shown in the deployed position, with the longitudinal vehicle direction x or the direction of travel x of the motor vehicle being indicated in each case for better orientation. In this case, the flow guiding element forms a trunk lid spoiler, which is disposed above the rear window 114.

1. A flow guiding device for being installed on a panel component of a motor vehicle, the flow guiding device comprising:
at least one flow guiding element configured to deflect headwind in a predetermined manner, and
a driving mechanism configured to move the at least one flow guiding element between a retracted position and at least one deployed position,
wherein the at least one flow guiding element comprises at least one environment sensor configured to send or receive electromagnetic signals for detecting a vehicle environment and to be moved between the retracted position and the at least one deployed position together with the at least one flow guiding element.

2. The flow guiding device according to claim 1, wherein the at least one environment sensor is integrated in or disposed on the at least one flow guiding element.

3. The flow guiding device according to claim 1, wherein the at least one flow guiding element comprises at least one see-through area through which the environment sensor can send or receive electromagnetic signals for detecting the vehicle environment.

4. The flow guiding device according claim 1, wherein the at least one flow guiding element comprises at least one cleaning mechanism having at least one cleaning nozzle, and the at least one cleaning nozzle is disposed on or integrated in the flow guiding element in such a manner that it can be moved between the retracted position and the at least one deployed position together with the flow guiding element.

5. The flow guiding device according to claim 1, wherein the at least one flow guiding element comprises at least one light source disposed on or integrated in the flow guiding element in such a manner that it can be moved between the retracted position and the at least one deployed position together with the flow guiding element.

6. The flow guiding device according to claim 1, wherein the driving mechanism comprises a hydraulic or pneumatic or electric or mechanical drive.

7. The flow guiding device according to claim 1, wherein the at least one environment sensor is configured to be activated by the movement of the at least one flow guiding element from the retracted position into the at least one deployed position and to be deactivated by the movement of the at least one flow guiding element from a deployed position into the retracted position.

8. The flow guiding device according to claim 1, wherein the at least one environment sensor is a lidar sensor or a radar sensor or a camera sensor or a multi-camera sensor.

9. A motor vehicle comprising: a panel component and at least one flow guiding device according to claim 1, the flow guiding device being disposed on the panel component in such a manner that the at least one flow guiding element can be moved between the retracted position and the at least one deployed position.

10. The motor vehicle according to claim 9, wherein the at least one flow guiding element is flush with the panel component when in the retracted position and at least partially protrudes from the panel component when in the at least one deployed position so as to act as a headwind spoiler.

11. The motor vehicle according to claim 9, wherein the at least one flow guiding element forms one of a front spoiler, a rear spoiler, a side spoiler, a trunk lid spoiler, a wind deflector of a sunroof, a wind deflector of a convertible vehicle or a wind deflector of a sliding roof when in the deployed state.

12. A roof module for forming a vehicle roof on a motor vehicle, the roof module comprising:
a panel component, which at least partially forms a roof skin of the vehicle roof,
the roof skin serving as an outer sealing surface of the roof module,
a roof opening system comprising a lid element configured to move so as to selectively open or close a roof opening, and
a flow guiding device according to claim 1, the flow guiding device being a wind deflector or a headwind spoiler and being disposed on the panel component in such a manner that it can move between the retracted position and the at least one deployed position.

13. The roof module according to claim 12, wherein the roof opening system comprises a sliding-roof kinematic system configured to open and close the roof opening by moving the lid element.

14. The roof module according to claim 13, wherein the sliding-roof kinematic system is configured to communicate with the driving mechanism or forms the driving mechanism itself.

15. A motor vehicle comprising a roof frame structure and a roof module according to claim 12, the roof module being configured to be mounted on top of the roof frame structure as a structural unit.

16. The flow guiding device according to claim 1, wherein the at least one environment sensor is configured to send and receive electromagnetic signals for detecting a vehicle environment.

17. The flow guiding device according to claim 1, wherein the at least one flow guiding element comprises at least one see-through area through which the environment sensor can send and receive electromagnetic signals for detecting the vehicle environment.

18. The flow guiding device according to claim 1, wherein the driving mechanism comprises at least two of a hydraulic and pneumatic and electric and mechanical drive.

19. The flow guiding device according to claim 1, wherein the at least one environment sensor is at least two environmental sensors selected from the group of a lidar sensor, a radar sensor, a camera sensor, a multi-camera sensor, and combinations thereof.
